(19) United States
(12) Patent Application Publication
(10) Pub. No.: US 2021/0236868 A1
(43) Pub. Date: Aug. 5, 2021

(54) SPRINKLER HAVING INTEGRATED ANTENNA FUNCTIONALITY

(71) Applicant: Marioff Corporation Oy, Vantaa (FI)

(72) Inventors: Wojciech Zimny, Gdansk (PL); Nazar Krutskevych, Gdansk (PL)

(21) Appl. No.: 15/734,973

(22) PCT Filed: Oct. 14, 2019
(86) PCT No.: PCT/EP2019/077795

§ 371 Date: Dec. 3, 2020

(30) Foreign Application Priority Data
Oct. 23, 2018 (EP) 18397527.5

(51) Int. Cl. A62C 35/68; A62C 99/00; H01Q 1/36

(52) U.S. Cl. CPC A62C 35/68; A62C 37/08; H01Q 1/36; A62C 99/009

(57) ABSTRACT

A fire suppression device including a nozzle body disposed about a central axis. The device also includes a bulb cage operatively coupled to the nozzle body. The device further includes an antenna integrally formed with at least one structural component of the fire suppression device.

### BACKGROUND OF THE INVENTION

The embodiments herein relate to water mist fire suppression systems and, more particularly, to a sprinkler having integrated antenna functionality.

Fire suppression systems typically involve sprinklers positioned strategically within an area where fire protection is desired. Rapidly emerging technology related to what is referred to as the Internet of Things (IoT) provides an opportunity to improve functionality of automatic fire suppression systems. Wireless and battery-less communication devices are vital components used in IoT structures, especially in industrial and safety critical applications. As such, network infrastructure equipped with antennae is required in such applications. However, existing solutions for wireless transmission require dedicated antennae and wiring separate from sprinklers. Installation is required in multiple locations of a room and in multiple items.

### BRIEF DESCRIPTION OF THE INVENTION

Disclosed is a fire suppression device including a nozzle body disposed about a central axis. The device also includes a bulb cage operatively coupled to the nozzle body. The device further includes an antenna integrally formed with at least one structural component of the fire suppression device.

In addition to one or more of the features described above, or as an alternative, further embodiments may include that the antenna is at least a portion of the bulb cage.

In addition to one or more of the features described above, or as an alternative, further embodiments may include that the antenna is at least a portion of the nozzle body.

In addition to one or more of the features described above, or as an alternative, further embodiments may include that the antenna is a magnetic antenna.

In addition to one or more of the features described above, or as an alternative, further embodiments may include that the magnetic antenna is used for passive RFID.

In addition to one or more of the features described above, or as an alternative, further embodiments may include that the bulb cage is formed in a helical spiral shape to form a coil of an inductive heating system.

In addition to one or more of the features described above, or as an alternative, further embodiments may include a wire electrically connected to the antenna, the wire located at least partially within an interior of the nozzle body.

In addition to one or more of the features described above, or as an alternative, further embodiments may include that ein the wire includes an input lead and an output lead, the input lead in contact with the antenna, the output lead disposed within the nozzle body.

In addition to one or more of the features described above, or as an alternative, further embodiments may include that the wire is insulated with a contact sleeve that is part of the nozzle body.

Also disclosed is a method of forming a fire suppression device. The method includes integrally forming an antenna with the fire suppression device, the antenna being part of at least one structural component of the fire suppression device.

In addition to one or more of the features described above, or as an alternative, further embodiments may include that the antenna is formed as part of a bulb cage of the fire suppression device.

In addition to one or more of the features described above, or as an alternative, further embodiments may include that the antenna is formed as part of a nozzle body of the fire suppression device.

In addition to one or more of the features described above, or as an alternative, further embodiments may include that the antenna is a magnetic antenna used for passive RFID.

In addition to one or more of the features described above, or as an alternative, further embodiments may include electrically connecting a wire to the antenna, the wire located at least partially within an interior of the nozzle body.

In addition to one or more of the features described above, or as an alternative, further embodiments may include insulating the wire with a contact sleeve located proximate a periphery of the nozzle body.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic illustration of a fire suppression system in operation;

FIG. 2 is a side elevational view of a sprinkler of the fire suppression system; and

FIG. 3 is a side, sectional view of the sprinkler.

### DETAILED DESCRIPTION OF THE INVENTION

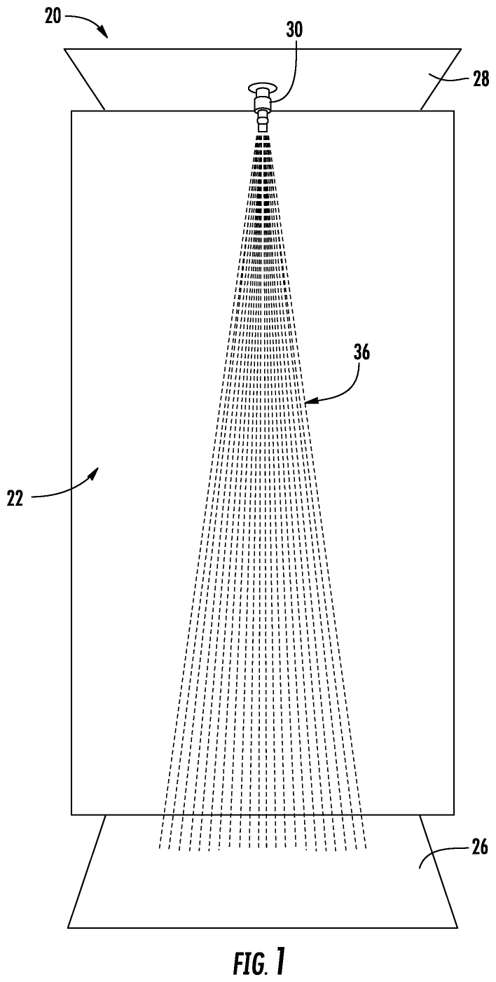

Referring to FIG. 1, schematically illustrated is a fire suppression system 20 that is used for suppressing or extinguishing a fire within an area 22. In the illustrated embodiment, the area 22 is a generally enclosed space such as a room within a building. The area 22 includes a generally horizontal surface 26. In one example, the horizontal surface 26 is a floor. In another example, the horizontal surface 26 is a platform within the area 22. A ceiling 28 is parallel to the surface 26 and is typically located proximate the top of the area 22. Other example areas or rooms may include angled surfaces that are not parallel to the surface 26 or may include surfaces at different heights relative to the surface 26. It is to be appreciated that the above examples of the area 22 and the horizontal surface 26 are merely illustrative of environments that the fire suppression system 20 may be employed within. To be clear, a target area is what is referred to by the horizontal surface 26, and the target area may include any surface of any orientation and may contain or include numerous contemplated articles, such as furniture, machinery, storage items, etc. Additionally, the target area may be a vertical surface, such as a wall of the area.

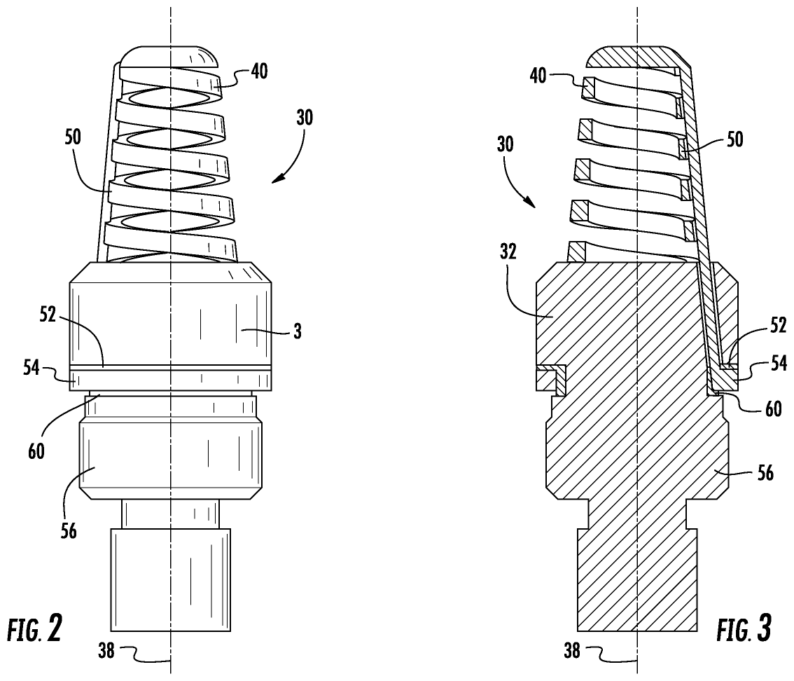

Fire suppression fluid, such as water, is provided by a source (not illustrated) through a piping network to a fire suppression water spray device, which may also be referred to as a sprinkler 30. The sprinkler 30 includes a nozzle body 32 (FIGS. 2 and 3) having a water plenum that is in fluid communication with one or more nozzles for expulsion to the area 22. The sprinkler 30 introduces fire suppression fluid into the area 22 when needed. The sprinkler 30 is positioned within the area 22 and configured to direct the fire suppression fluid along a primary trajectory 36 that is aimed toward the target area. In this example, the primary trajectory 36 is aimed directly at a floor surface 26, but as described above, the target area may be any alternative surface of the area 22.

Referring now to FIGS. 2 and 3, the sprinkler 30 is illustrated in greater detail. The nozzle body 32 is oriented about a central axis 38 that extends longitudinally through the nozzle body 32. The water plenum located at an interior location of the nozzle body 32 is in fluid communication with one or more nozzles for expulsion of fire suppression fluid (e.g., water). A bulb cage 40 is operatively coupled to the nozzle body 32. In one embodiment, the bulb cage 40 is machined to be integrally formed with the nozzle body 32 to form a permanent securement thereto.

Rapidly emerging technology related to what is referred to as the Internet of Things (IoT) provides an opportunity to improve functionality of automatic fire suppression systems, such as the embodiments of the fire suppression system 20 disclosed herein. Wireless and battery-less communication devices are vital components used in IoT structures, especially in industrial and safety critical applications. As such, network infrastructure equipped with antennae is required in such applications. The embodiments of the sprinkler 30 described herein avoid the need for dedicated antennae and wiring that is separate from the sprinkler, as required by prior wireless transmission structures. Therefore, the need for installation in multiple locations of multiple items in a room is avoided, as one can appreciate from the disclosure herein.

The sprinkler 30 disclosed herein utilizes at least one of its physical structural features to be an antenna 50 that may function as a communication device that facilitates wireless and/or battery-less communication capability. In other words, the antenna 50 is an integrated feature of the sprinkler 30. The integrated antenna 50 may provide numerous functional capabilities associated with the overall fire suppression system 20 operation. For example, the antenna can provide a wireless interface for TRLS tags worn by vessel passengers, wireless conductivity for devices forming fire alarm systems (e.g., detectors, sirens, etc.), RFID functionality for a device associated with the sprinkler 30, wireless communication between sprinklers and a management system for transmission of critical parameters (presence, integrity, health, etc.), wireless interface for remote, on demand release of the sprinkler 30, and mesh routing in any of the above-noted functionality scenarios. The preceding list of examples is merely illustrative of the functional benefits associated with the integrated antenna 50 and is not intended to be limiting of the functions that may be associated with the antenna 50. In some embodiments, the antenna 50 is the nozzle body 32. In other embodiments, the antenna 50 is the bulb cage 40. In still other embodiments, the antenna 50 is a combination of the nozzle body 32 and the antenna 50. Regardless of the precise portion of the sprinkler 30 that is the antenna 50, it is to be understood that the antenna 50 is actually an integrated physical structural feature of the sprinkler 30 and is not a separate antenna that is added to the sprinkler 30. Therefore, the antenna 50 is a physical structure of the sprinkler 30 that also provides a traditional function of the sprinkler operation (e.g., nozzle body 32, bulb cage 40, etc.).

The antenna 50 is a magnetic antenna in some embodiments that may be utilized for passive RFID identification. In the illustrated embodiment, the bulb cage 40 is formed as a helical spiral shape. This shape allows the bulb cage 40 to be used as a coil of an inductive heating system or for wireless charging to transfer energy to an object enclosed in the bulb cage 40 or outside of it. The coil functionality may be used for wireless energy transfer to the bulb cage 40 of the sprinkler 30. Temperature sensing is also provided via coil resistance depending on the temperature, for example as a resistive temperature detector (RTD).

The antenna 50 is electrically connected to one or more other components via a wire 52 in some embodiments. The wire is located at least partially within the sprinkler 30. For example, the wire 52 may be hidden inside the sprinkler 30 structure with a contact sleeve 60 at the base of the sprinkler 30. The contact sleeve 60 may provide insulation for the wire in some embodiments. In the illustrated embodiment, an input lead 54 is in contact with the antenna 50 and extends to an output lead 56 that is within the nozzle body 32. Such an arrangement makes the connections invisible and hidden in an unexposed part of the sprinkler system. For example, the connections may be hidden under a decoration plate or behind a ceiling.

The sprinkler 30 described herein creates an opportunity to use wireless and battery-less solutions for a sprinkler that is part of a fire suppression system. Additionally, a single installation point is possible, thereby reducing labor cost and complexity. The integrated antenna 50 and hidden electrical connection features provide attractive aesthetic value. Also, by manufacturing the bulb cage 40 using traditional technology would eliminate part of the CNC machining that is typically required and lower production cost.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fire suppression device comprising:
a nozzle body disposed about a central axis;
a bulb cage operatively coupled to the nozzle body; and
an antenna integrally formed with at least one structural component of the fire suppression device.

2. The fire suppression device of claim 1, wherein the antenna is at least a portion of the bulb cage.

3. The fire suppression device of claim 1, wherein the antenna is at least a portion of the nozzle body.

4. The fire suppression device of claim 1, wherein the antenna is a magnetic antenna.

5. The fire suppression device of claim 4, wherein the magnetic antenna is used for passive RFID.

6. The fire suppression device of claim 1, wherein the bulb cage is formed in a helical spiral shape to form a coil of an inductive heating system.

7. The fire suppression device of claim 1, further comprising a wire electrically connected to the antenna, the wire located at least partially within an interior of the nozzle body.

8. The fire suppression device of claim 7, wherein the wire includes an input lead and an output lead, the input lead in contact with the antenna, the output lead disposed within the nozzle body.

9. The fire suppression device of claim 7, wherein the wire is insulated with a contact sleeve that is part of the nozzle body.

10. A method of forming a fire suppression device comprising integrally forming an antenna with the fire suppression device, the antenna being part of at least one structural component of the fire suppression device.

11. The method of claim 10, wherein the antenna is formed as part of a bulb cage of the fire suppression device.

12. The method of claim 10, wherein the antenna is formed as part of a nozzle body of the fire suppression device.

13. The method of claim 10, wherein the antenna is a magnetic antenna used for passive RFID.

14. The method of claim 10, further comprising electrically connecting a wire to the antenna, the wire located at least partially within an interior of the nozzle body.

15. The method of claim 14, further comprising insulating the wire with a contact sleeve located proximate a periphery of the nozzle body.
